(19) United States
(12) Patent Application Publication
(10) Pub. No.: US 2005/0173355 A1
(43) Pub. Date: Aug. 11, 2005

(54) Multi-section retaining/sorting/browsing apparatus

(76) Inventor: David M. Stravitz, New York, NY (US)

Correspondence Address: FRISHAUF, HOLTZ, GOODMAN & CHICK, PC, 220 5TH AVE FL 16, NEW YORK, NY, 10001-7708, US

(21) Appl. No.: 11/102,367

(22) Filed: Apr. 8, 2005

Related U.S. Application Data
(63) Continuation-in-part of application No. 11/040,806, filed on Jan. 21, 2005.
Application No. 11/040,806 is a continuation-in-part of application No. 10/702,205, filed on Nov. 4, 2003.

(51) Int. Cl. B42F 17/00

(52) U.S. Cl. 211/11

(57) ABSTRACT

Multi-section retaining/sorting/browsing apparatus including a base including a plurality of parallel slots vertically spaced apart from one another and a plurality of dividers each arranged in connection with a respective pair of slots. Adjacent dividers define object-retaining sections therebetween and support surfaces for objects to be retained in the object-support sections at different vertical elevations. Each divider has a pair of separated anchor portions and an object support portion coupled to the anchor portions to provide a support for retaining objects. The anchor portions are rotatably retained in connection with the base to enable the dividers to be flipped forward and backward in a longitudinal direction. When file folders or other objects are retained in the object-retaining sections, it becomes possible to sort papers, documents or files in the sections and to browse through the contents of a file folder without removing them from the apparatus.

### CROSS-REFERENCE TO RELATED APPLICATION

This application is a continuation-in-part of U.S. patent application Ser. No. 11/040,806 filed Jan. 21, 2005 which is a continuation-in-part of U.S. patent application Ser. No. 10/702,205 filed Nov. 4, 2003, the specifications of which are incorporated by reference herein.

### FIELD OF THE INVENTION

The present invention relates to an apparatus which defines a plurality of retaining sections each of which is capable of receiving various objects and which enables easy sorting of objects as well as browsing of the objects received in the retaining sections. More particularly, the present invention relates to such an apparatus which can be mounted to a wall or other vertical surface, in addition to being capable of resting on a horizontal surface such as a desk.

### BACKGROUND OF THE INVENTION

In an office setting, a common situation arises in which papers or documents must be retained and/or sorted. For example, it might be required to create ten different booklets with each booklet having twenty sequentially numbered pages. If the twenty pages are printed one at a time in batches of ten (one for each booklet), then they will have to be sorted with one page being allotted to each booklet.

A multi-section retaining/sorting/browsing apparatus is often used for this purpose and includes a plurality of dividers which define object-retaining sections therebetween into which the pages can be placed sequentially. That is, first the page numbered 1 is placed in each section, then the page numbered 2 is placed behind page number 1 in each section, and so on until ten complete booklets are created. When placing a page in each section, the dividers may be flipped to expose that section and after the page is placed in that section, a divider may be flipped to expose an adjacent section. The sorting process continues in this manner by flipping the dividers and inserting pages into each exposed section. Alternatively, sorting can be done in reverse, starting with the last page. Using this technique, flipping of the dividers may be avoided.

Such multi-section retaining/sorting/browsing apparatus are also used to hold file folders to enable papers to be stored and/or sorted into the file folders. In this case, a file folder can be retained in each section and opened one at a time by flipping the dividers (without removing the file folder) and one or more pages or documents may be placed into each file folder as it is opened.

The same apparatus also enables browsing through the file folders retained in the apparatus. For example, by flipping the dividers to expose the file folders in each section, it is possible to view the contents of each file folder without removing the file folders from the apparatus. By placing the file folders in the sections defined by the apparatus, it is not required to remove the file folders to open each one but rather, the file folders can be continually retained in the sections in the apparatus and by flipping the dividers, each file folder can be opened and browsing of the contents thereof is possible.

A problem with the conventional multi-section retaining/sorting/browsing apparatus of this type is that not all of the known devices allow for a file folder in a particular section to be opened without requiring the exertion of pressure to keep the dividers in place and that section exposed.

A multi-section retaining/sorting/browsing apparatus is often also used to display small objects for sale, wherein it is desired to ease the purchaser's ability to browse through the objects. In particular in the sale of multi-media objects, such as CDs, DVDs, records and computer software, it is desirable to enable a purchaser to relatively easily and quickly flip through the objects to see whether any are of interest for possible purchase. To this end, by providing a retaining/sorting/browsing apparatus including a plurality of dividers which define object-retaining sections therebetween into which the multi-media objects are placed, the purchaser can easily flip the dividers, or the objects depending on which is larger, forward or backward to view the objects in each section. If the objects are larger and thus flipped, then the dividers are flipped upon flipping of the objects.

Unfortunately, retaining/sorting/browsing devices are not always designed so that easy flipping is provided in combination with the ability to allow the user or purchaser to expose an object or objects in one or more of the object-retaining sections without exerting pressure to keep the dividers in position so that the desired section is exposed.

### OBJECTS AND SUMMARY OF THE INVENTION

Accordingly, it is an object of the invention to provide a new and improved multi-section retaining/sorting/browsing apparatus.

It is another object of the present invention to provide a new and improved multi-section retaining/sorting/browsing apparatus including a plurality of object-retaining sections and which is designed to facilitate easy sorting of objects into each section.

It is still another object of the present invention to provide a new and improved multi-section retaining/sorting/browsing apparatus including a plurality of object-retaining sections and which enables exposure and viewing of an object or objects such as file folders in one or more of the object-retaining sections preferably without exerting pressure to keep the dividers in place and that section exposed.

It is yet another of the present invention to provide a new and improved multi-section retaining/sorting/browsing apparatus which is easy to assemble.

It is still another object of the present invention to provide a new multi-section retaining/sorting/browsing apparatus including a plurality of object-retaining sections which is capable of being mounted to a vertical surface such as a wall and also capable of resting on a horizontal surface such as a desk.

It is yet another object of the present invention to provide a new and improved multi-section retaining/sorting/browsing apparatus which enables multiple configurations of dividers on a base, with the dividers being easily re-configurable.

In order to achieve these objects and others, a multi-section retaining/sorting/browsing apparatus in accordance with the invention includes a base including a plurality of pairs of parallel slots vertically spaced from one another and a plurality of dividers each arranged in connection with a respective pair of slots. Adjacent dividers define object-retaining sections therebetween and support surfaces for objects to be retained in the object-support sections at different vertical elevations.

With such an apparatus, it becomes possible to more easily view file folders in the object-retaining sections at the rear of the apparatus since such would be elevated above the file folders in the object-retaining sections at the front of the apparatus. It is also possible to place file folders in each section to enable sorting of papers or documents into the file folders in the sections and browse through the file folders without removing them from the apparatus.

In some embodiments, each divider has a pair of separated anchor portions and an object support portion coupled to the anchor portions to provide a support for retaining objects. The anchor portions are rotatably retained in connection with the base to enable the dividers to be flipped forward and backward in a longitudinal direction. Specifically, part of the anchor portions are retained and rotatable in the slots.

The base may comprise an outer support member and an inner mounting member defining an opening therebetween with the dividers extending through the opening. The outer support member may include opposed, inwardly extending flanges in which the slots are defined. The inner member may include a substantially planar rear wall having a base portion and a divider portion, and a transverse wall separating the base portion and the divider portion. The divider portion forms an object-retaining section with an uppermost divider, while the transverse wall provides support for objects retained in the uppermost object-retaining section. The inner member may also include side walls having forward projections arranged in the slots to thereby secure the anchor portions to the base.

Various forms of dividers are possible. In one embodiment, each divider includes a substantially planar object support portion, an arcuate shelf extending from a rear surface of the object support portion and a pair of anchor portions coupled to the object support portion. The shelf includes a curved support wall having a pair of cut-outs, side walls alongside the cut-outs and slots formed below the side walls. The side walls of each divider are arranged in the slots of an immediately higher divider. This construction of the side walls and slots serves to limit forward tilting movement of the dividers. Further, the dividers may each include an arcuate opening extending from a bottom edge between the anchor portions whereby the shelf of an immediately lower divider passes through the arcuate opening of each divider.

For wall-mounting uses, the base includes a mounting arrangement arranged in connection with a rear wall for mounting the base to a vertical surface, e.g., mounting holes.

Optionally, the base includes one or more drawers each defining a compartment and rotatable outward from a front face of the base to expose the compartment. A locking mechanism to lock the drawer(s) to the base may also be provided.

Another embodiment of a multi-section retaining/sorting/browsing apparatus in accordance with the invention comprises a base including a plurality of parallel slots, and a plurality of dividers each removably arranged in connection with a respective slot on the base. The dividers define object-retaining sections between adjacent dividers. Each divider includes slits extending upward from a lower edge thereof to form outwardly biased spring portions. The spring portions enable the dividers to be removably inserted into and removable from engagement with the base through the slots. To this end, the spring portions alone or the dividers in their entirety are made of a resilient material.

Each divider may include a pair of separated anchor portions and an object support portion coupled to the anchor portions and extending through the respective slot to provide a support for retaining objects. The anchor portions are rotatably retained in connection with the base to enable the dividers to be flipped forward and backward in a longitudinal direction. The slits can be formed through the anchor portions.

Each anchor portion may include a projection extending outwardly to a position below an overlying portion of the base, the projections being formed on the spring portions.

To expand the possible uses of the apparatus, the base preferably defines more slots that the number of dividers so that multiple, different configurations of dividers on the base are possible. As such, different sizes of object-retaining sections can be provided and the configuration of object-retaining sections can be changed as desired.

### BRIEF DESCRIPTION OF THE DRAWINGS

The invention, together with further objects and advantages thereof, may best be understood by reference to the following description taken in conjunction with the accompanying drawings, wherein like reference numerals identify like elements.

FIG. 1 is a perspective view of a multi-section retaining/sorting/browsing apparatus in accordance with the invention in use while retaining file folders and a media storage package.

FIG. 2 is a side view of the multi-section retaining/sorting/browsing apparatus shown in FIG. 1

FIG. 3A is a cross-sectional view taken along the line 3-3 in FIG. 2 of the multi-section retaining/sorting/browsing apparatus in accordance with the invention shown in FIG. 1.

FIG. 3B is a cross-sectional view taken along the line 3-3 in FIG. 2 of another embodiment of a multi-section retaining/sorting/browsing apparatus in accordance with the invention.

FIG. 3C is a cross-sectional view taken along the line 3-3 in FIG. 2 of still another embodiment of a multi-section retaining/sorting/browsing apparatus in accordance with the invention.

FIG. 4A is a cross-sectional view taken along the line 4A-4A in FIG. 3A of the multi-section retaining/sorting/browsing apparatus in accordance with the invention shown in FIG. 1.

FIG. 4B is a cross-sectional view taken along the line 4B-4B in FIG. 3B.

FIG. 4C is a cross-sectional view taken along the line 4C-4C in FIG. 3C.

FIG. 5 is an enlarged view of the area encircled by arrows 5-5 in FIG. 3C.

FIG. 6 is a top view of a base of the multi-section retaining/sorting/browsing apparatus in accordance with the invention shown in FIG. 1.

FIG. 7 is a top view of another base for a multi-section retaining/sorting/browsing apparatus in accordance with the invention.

FIG. 8 is a side view of another base for a multi-section retaining/sorting/browsing apparatus in accordance with the invention.

FIG. 8A is an enlarged partial sectional view of the lower portion of the embodiment of FIG. 8.

FIG. 9 is a top, front perspective view of another embodiment of a multi-section retaining/sorting/browsing apparatus in accordance with the invention.

FIG. 9A is a cross-sectional view taken along the line 9A-9A in FIG. 9.

FIG. 9B is a cross-sectional view taken along the line 9B-9B in FIG. 9A.

FIG. 9C is a cross-sectional view taken along the line 9C-9C in FIG. 9B.

FIG. 10 is an exploded view of the multi-section retaining/sorting/browsing apparatus in accordance with the invention shown in FIG. 9.

FIG. 11 is a top, front perspective view of another embodiment of a multi-section retaining/sorting/browsing apparatus in accordance with the invention.

FIG. 12 is another perspective view of the multi-section retaining/sorting/browsing apparatus shown in FIG. 11.

FIG. 13 is an exploded view of the multi-section retaining/sorting/browsing apparatus shown in FIG. 11.

FIG. 14 is a perspective sectional view of the multi-section retaining/sorting/browsing apparatus shown in FIG. 11.

FIG. 15 is a sectional view of the multi-section retaining/sorting/browsing apparatus shown in FIG. 11.

FIG. 16 is a perspective view of another embodiment of a multi-section retaining/sorting/browsing apparatus in accordance with the invention similar to that shown in FIG. 11.

FIG. 17 is a perspective view of another embodiment of a multi-section retaining/sorting/browsing apparatus in accordance with the invention.

FIG. 18 is a cross-sectional view taken along the line 18-18 of FIG. 17.

FIG. 19 is an exploded view of the multi-section retaining/sorting/browsing apparatus shown in FIG. 17.

### DETAILED DESCRIPTION OF THE INVENTION

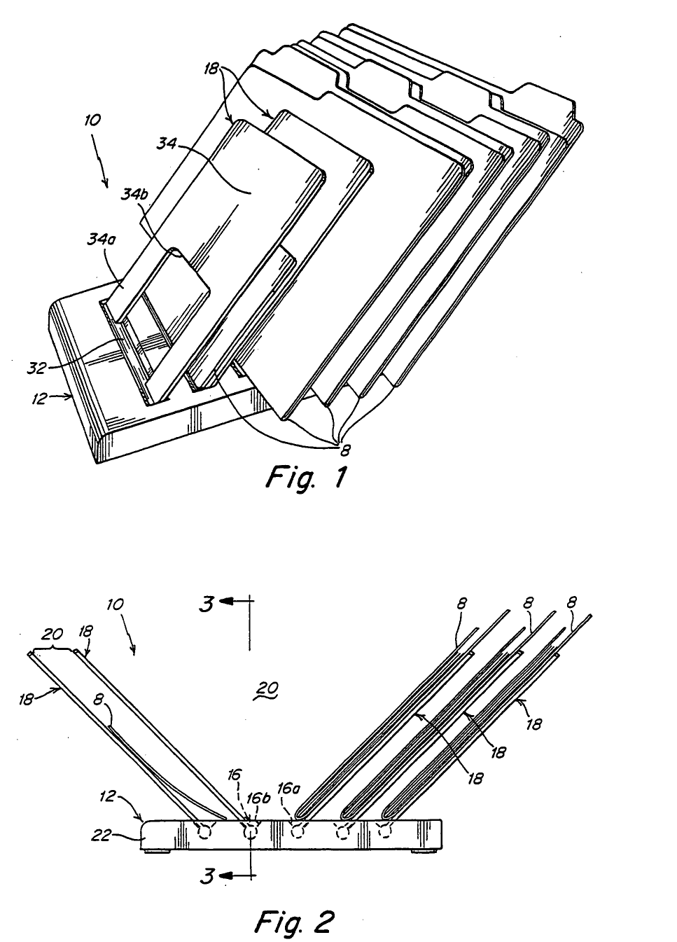

Referring to the accompanying drawings wherein like reference numerals refer to the same or similar elements, a multi-section retaining/sorting/browsing apparatus in accordance with the invention is designated generally as 10 and comprises a base 12 defining one or more cavities 14 (see FIG. 4A) and including a plurality of parallel slots 16. The apparatus 10 also includes dividers 18 arranged in connection with the slots 16 in the base 12 and extending at least partially into the cavity(ies) 14. The dividers 18 define object-retaining sections 20 therebetween, i.e., one object-retaining section 20 is defined between each adjacent pair of dividers 18 (see FIG. 2). Objects 8, such as file folders or the like, are shown in the object-retaining sections 20.

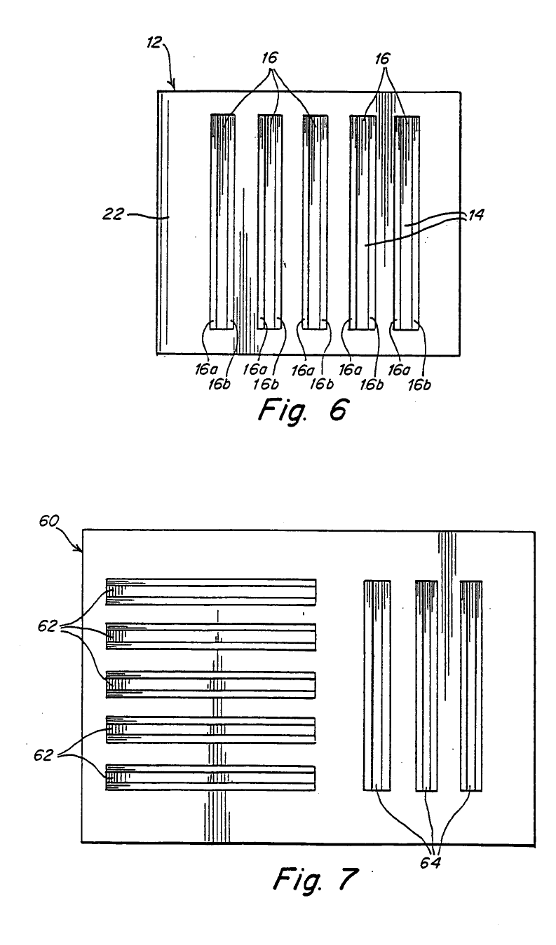

To establish a convention for the following description and without limiting the invention, in the embodiment shown in FIGS. 1-6 and 8, all of the slots 16 extends in a transverse direction of the base 12 and the slots 16 are therefore arranged alongside and substantially parallel to one another in a longitudinal direction of the base 12.

In some embodiments, a single cavity 14 is provided in the base 12, in which case, all of the slots 16 communicate with the single cavity 14 and a portion of each divider 18 is situated in the single cavity 14. On the other hand, if a plurality of cavities 14 are provided in the base 12 (see FIG. 4B), each slot 16 can be arranged to communicate with a respective cavity 14, i.e., there are an equal number of cavities 14 and slots 16. Nevertheless, it is also possible to have multiple cavities 14 with each cavity 14 communicating with a plurality of slots 16.

All of the slots 16 may have the same size for receiving dividers 18 having the same length as shown in FIG. 1. In this case, a single cavity 14 can be formed in the base 12. However, if it is desired to provide two or more sets of dividers with each set having a different length, then two or more cavities can be formed in the base, with each cavity having a length in a transverse direction designed to accommodate a respective set of dividers.

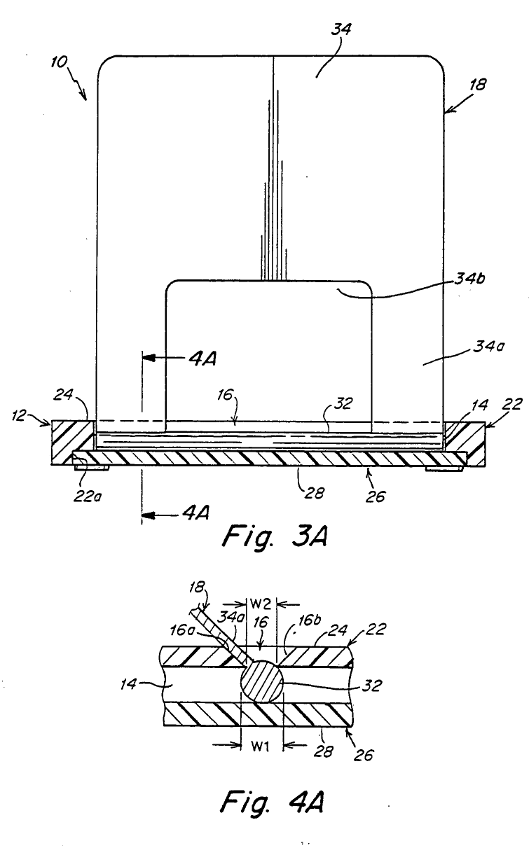

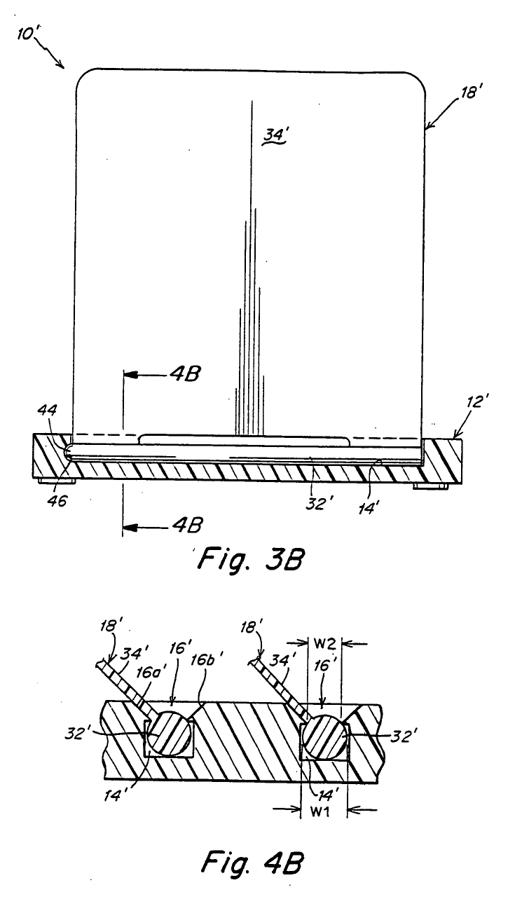

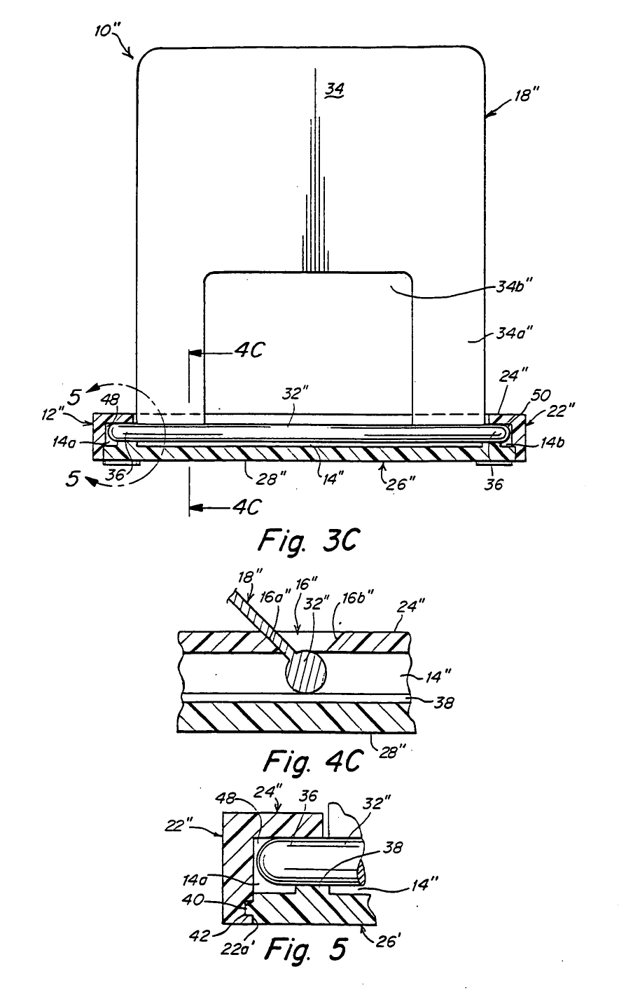

The base 12 may be formed from two members, an upper member 22 defining a top wall 24 of the cavity or cavities 14 and a lower member 26 (see FIG. 3A) defining a bottom wall 28 of the cavity or cavities 14. The upper member 22 may include an opening in a bottom surface 22a into which the lower member 26 is positioned and then either permanently or removably attached to the upper member 22. A permanent form of connection for the upper and lower members 22, 26 may be provided by an adhesive such as glue or fastener members such as nails, screws and the like. A removable form of connection for the upper and lower members 22, 26 may be provided by a releasable locking member shown in FIG. 5, e.g., a projection 40 formed on the lower member 26 which engages with a recess 42 formed on the upper member 22″ whereby the portion of the upper member 22″ including the recess 42 is slightly flexible to enable outward flexing thereof and removal of the lower member 26″ from engagement with the upper member 22″.

Referring now to FIGS. 3A and 4A, in a first embodiment of the invention, a single cavity 14 is provided and the plurality of slots 16 all communicate with this cavity 14. The slots 16 are arranged in the top wall 24 of the upper member 12 and have substantially the same transverse length as the cavity 14.

Each divider 18 has an anchor portion 32 arranged in the cavity 14 and an object support portion 34 coupled to the anchor portion 32 and extending through a respective slot 16 to provide a support for retaining the objects 8 (see FIG. 2). To retain the dividers 18 in the base 12, the anchor portion 32 has a larger width W1 (the diameter when the anchor portion is cylindrical) than the smallest width W2 of the slot 16 (W1>W2) so that the anchor portion 32 cannot pass through the slot 16 once placed in the cavity 14 during assembly of the apparatus 10 (described below).

To enable a limited amount of flipping of the dividers 18 during use of the apparatus 10, each slot 16 is preferably defined by downwardly angled surfaces 16a,16b of the top wall 24 of the base 12. As such, a smaller opening is formed in a lower surface of the top wall 24 than in an upper surface of the top wall 24 for each slot 16 (see FIG. 4A). The dividers 18 are thus rotatable over an angular range defined by the angled surfaces 16a,16b.

The anchor portion 32 is rotatable in the cavity 14 to enable the divider 18 to be flipped forward and backward in a longitudinal direction (see FIG. 2) wherein two dividers 18 are shown having been flipped forward whereas three dividers 18 are shown having been flipped backward in which case, an object-retaining section 20 between the second and third dividers 18 is exposed). When flipped forward, the divider 18 will rest against the rearward facing angled surface 16a and when flipped rearward, the divider 18 will rest against the forward facing angled surface 16b.

To enable passage of the object support portion 34 through the respective slot 16, a part 34a of the object support portion 34 has a length in the transverse direction equal to or less than the length of the respective slot 16. The object support portions 34 may be substantially planar and directly connected to the anchor portions 32. Also, the object support portions 34 may be provided with different forms or shapes as desired, e.g., with a recess 34b as shown, and from different materials (i.e., metal, plastics, wood, etc).

To assemble the apparatus 10, the upper and lower members 22, 26 and dividers 18 are first constructed and the dividers 18 are inserted through the slots 16 by inserting the object support portions 34 of the dividers 18 through the slots 16 until the anchor portions 32 come into contact with the lower surface of the top wall 24 of the upper member 22. Then, the lower member 26 is inserted into the opening 22a in the upper member 22 and attached to the upper member 22. The apparatus is thus ready for use for retaining objects, for enabling sorting of objects such as papers and documents, and for enabling browsing of objects such as file folders.

Referring now to FIGS. 3B and 4B, another embodiment of the multi-section retaining/sorting/browsing apparatus in accordance with the invention (designated 10′) includes a base 12′ which has a unitary construction formed with a plurality of cavities 14′ and parallel slots 16′, each slot 16′ communicating with a respective one of the cavities 14′ (although it is also possible to form a single cavity in the base 12′ communicating with a plurality of or all of the slots 16′ as described above).

Dividers 18′ are retained in the cavity 14′ by virtue of the anchor portion 32′ having a width W1 (the diameter of the anchor portion since the anchor portion 32 is cylindrical) larger than the width W2 of the slots 16′ (see FIG. 4B). As such, the anchor portion 32′ cannot pass upwardly through the slot 16′.

Since the base 12′ has a unitary construction, the assembly method described above cannot be used for this embodiment. In this embodiment therefore, in order to place the dividers 18′ into the slots 16′ in the assembly of the apparatus 10′, the anchor portion 32′ of the dividers 18′ (and possibly also the object support portion 34′) are formed from a material which provides a small degree of resiliency, such as some types of molded plastics, so that the anchor portions 32′ of the dividers 18′ can be pressed (i.e., forced) downwardly along the inclined surfaces 16a′, 16b′ into the slots 16′.

Optionally, as shown in FIG. 3B, one or both transverse ends of the anchor portion 32′ may include a projection 44 which is engaged with a recess 46 in an inner wall defining the cavity 14′ to more securely retain the dividers 18′ in the slots 16′. One or both of the transverse ends of the anchor portion could also be provided with a recess while the inner wall of the cavity 14′ is provided with a complementary projection.

Assembly of the apparatus 10′ would therefore entail simply pressing each divider 18′ into a respective slot 16′, and so that the projection on the divider 18's enters into the recess 46 in the inner wall of the base 12′ defining the cavity 14′ if present.

Referring now to FIGS. 3C, 4C and 5, another embodiment of the multi-section retaining/sorting/browsing apparatus in accordance with the invention (designated 10″) includes a base 12″ defining a single cavity 14″ and a plurality of slots 16″ all communicating with the cavity 14″. The base 12″ is comprised of an upper member 22″ and a lower member 26″. The apparatus 10″ may have the same features of the embodiment described in FIGS. 3A and 4A unless otherwise noted or inconsistent with the following description and the same elements are now followed by the notation (″).

Retention of the dividers 18″ in connection with the base 12″ is provided by constructing the anchor portion 32″ of the dividers 18″ to have a larger transverse length than the transverse length of the slots 16″, and specifically, to extend beyond each transverse end of the slots 16″. Thus, the slots 16″ are formed in the top wall 24″ of the upper member 22″ so that each slot 16″ has a first transverse end 48 spaced inward from an adjacent end 14a of the cavity 14″ and a second transverse end 50 spaced inward from an adjacent end 14b of the cavity 14″ (see FIGS. 3C and 5). An overhanging portion of the top wall 24″ is thus arranged above the cavity 14″ alongside each of the slots 16″. The anchor portion 32″ of each divider 18″ includes a projection 36 at each transverse end which is situated below the overhanging portion of the top wall 24″.

The projections 36 are secured in the base 12″ between the top wall 24″ and the bottom wall 28″ to enable rotation of the anchor portion 32″ and thus the divider 18″. To this end, the projections 36 may be supported on raised shoulders 38 of the bottom wall 28″ so that the projections 36 are positioned between the shoulders 38 and the overhanging portion of the top wall 24″ defined by the upper member 22″ (see FIGS. 3C and 4C). The anchor portion 32″ of each divider 18″ may be substantially cylindrical with the projections 36 being rounded in the form of bullets.

To assemble the apparatus 10″, the upper and lower members 22″, 26″ and dividers 18″ are first constructed and the dividers 18″ are inserted through the slots 16″ by inserting the object support portions 34″ of the dividers 18″ through the slots 16″ until the anchor portions 32″ come into contact with the lower surface of the top wall 24″ of the upper member 22″. Then, the lower member 26″ is inserted into the opening in the upper member 22″ and attached to the upper member 22″. The apparatus is thus ready for use for retaining objects, for enabling sorting of objects such as papers and documents, and for enabling browsing of objects such as file folders. The dividers 18″ may be pressed down into slots 16″ as described above with reference to FIGS. 3B and 4B when the materials have sufficient resiliency.

As shown in FIG. 7, a multi-section retaining/sorting/browsing apparatus in accordance with the invention can include a base 60 which has two sets of parallel slots 62,64 oriented in different directions. The base 60 can be designed in any of the ways described above to accommodate any of the particular dividers described above. For example, the base 60 can be fabricated from two components and each slot 62,64 can be provided with a smaller width than the width of the divider to received in the slot. The same features of the embodiments shown in FIGS. 1-6 can be applied to this embodiment as well, to the extent possible.

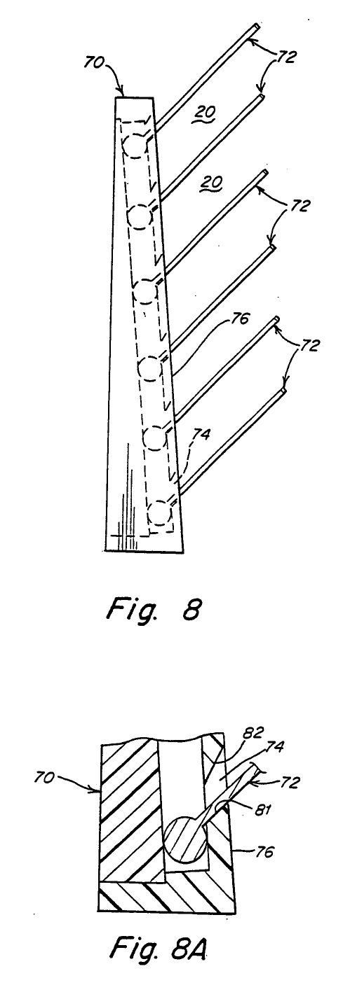

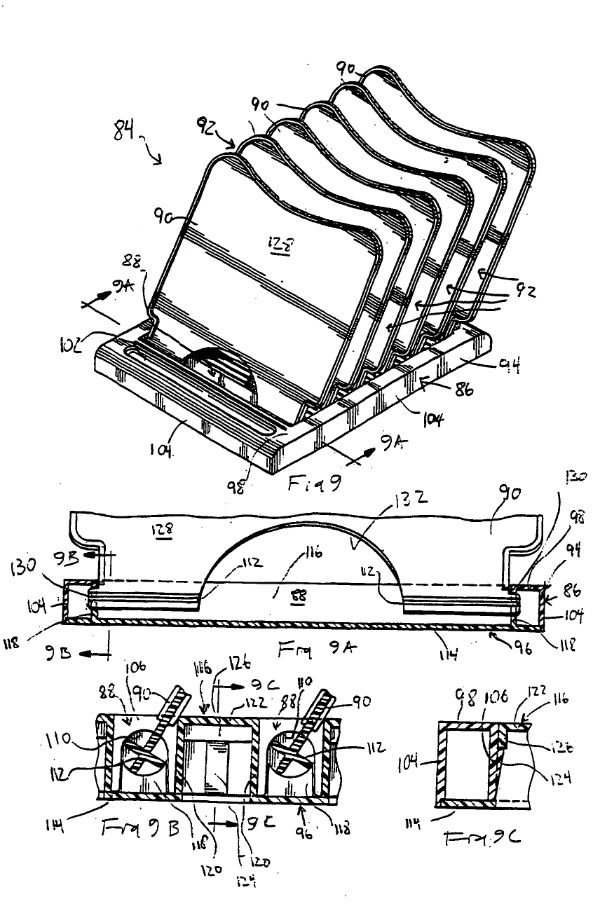

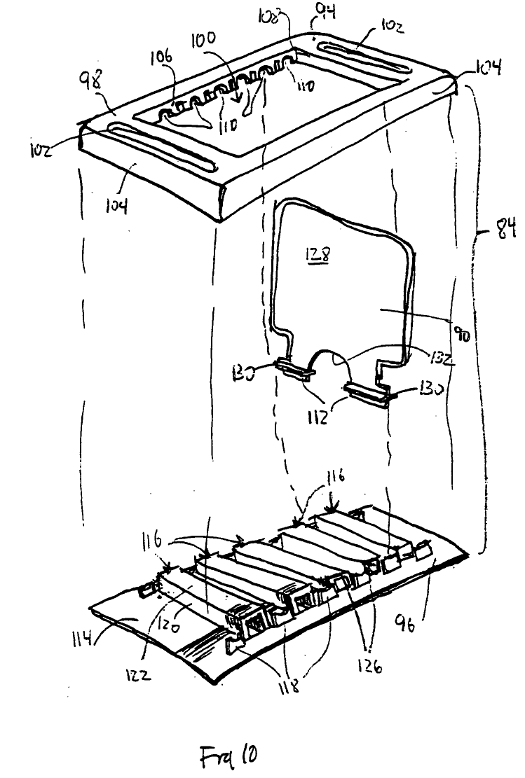

Although in the embodiments described above, the slots are formed in a top wall of the base, other forms and shapes of the base can be constructed in which the slots are formed in other walls of the base. For example, FIG. 8 shows a wall-mountable embodiment including a base 70 mountable to a wall, via appropriate mounting means such as nails, screws, adhesive and the like, and dividers 72 wherein slots 74 are formed in an angled side wall 76 of the base 70. The angled surfaces 81, 82 defining the slots 74 are formed to limit the angular orientation of the dividers 72 and therefore to enable objects to be retained in object-retaining sections 20 formed between adjacent pairs of the dividers 72. For example, as shown in FIG. 8A, lower angled surface 81 defines the lower limit to which divider 72 can travel. The lower angled surface 81 may be around 45° from the horizontal, and the upper angled surface 82 may be around 60° or more from the horizontal. Other angles, of course, could be used. Other angular orientations can be used, as desired.

Referring now to FIGS. 9, 9A, 9B, 9C and 10, another embodiment of a multi-section retaining/sorting/browsing apparatus in accordance with the invention is designated generally as 84 and comprises a base 86 including a plurality of parallel slots 88 and dividers 90 arranged in connection with the slots 88. Slots 88 extend in a transverse direction of the base 86 and are therefore arranged alongside and substantially parallel to one another in a longitudinal direction of the base 86. The dividers 90 define object-retaining sections 92 therebetween, i.e., one object-retaining section 92 is defined between each adjacent pair of dividers 90. Objects, such as file folders or the like, can be retained in the object-retaining sections 92.

The base 86 is formed from two separate members, an upper member 94 and a lower member 96 (see FIG. 10). Upper member 94 includes a top wall 98 defining an opening 100 and having a transversely extending receptacle 102 on each longitudinal side of the opening 100. Receptacles 102 are designed to accommodate pencils, pens or other writing implements, or paper clips, erasers and other types of office products. Upper member 94 also includes peripheral side walls 104 and transversely extending flanges 106 projecting downward from the top wall 98 alongside opening 100. Upper member 94 also includes longitudinally extending flanges 108 projecting downward from the top wall 98 alongside the opening 100. Each longitudinally extending flange 108 defines end walls of the slots 88 and includes a plurality of curved slots or indentations 110 under which part of an X-shaped anchor portion 112 of a respective divider 90 is placed (see FIG. 9B).

Lower member 96 includes a planar portion 114, a plurality of transversely extending elevated sections 116 arranged on the upper surface of the planar portion 114 and a plurality of support projections 118 arranged on the upper surface of the planar portion 114. Each elevated section 116 includes a pair of vertical walls 120 and a horizontal wall 122 raised above the planar portion 114 by the vertical walls 120. Instead of a pair of vertical walls 120, other constructions for raising or elevating horizontal wall 122 above the planar portion 114 of the lower member 96 are also possible. The horizontal walls 122 of the elevated sections 116 preferably positioned to be even with the top wall 98 of the upper member 94.

Support projections 118 define a curved bearing surface on which part of the anchor portions 112 of the dividers 90 are supported and rotate (see FIG. 9B).

Slots 88 are defined, on the longitudinal sides, by a pair of vertical walls 120 or, in the case of the slots 88 at the longitudinal ends of the base 86, by one vertical wall 120 and an opposed transversely extending flange 108. As such, flipping movement of the dividers 90 arranged in connection with the slots 88 is limited by contact with the elevated sections 116, or by contact with the upper wall 98 of the upper member 94. On the transverse sides, the slots 88 are defined by part of the longitudinally extending flanges 106 and support projections 118.

The upper member 94 may include an opening in a bottom surface into which the lower member 96 is positioned and then either permanently or removably connected to the upper member 94. For example, connecting structure may be provided on the upper and lower members 94, 96 to securely connect the upper and lower members 94, 96 together. Specifically, the upper member 94 includes angled projections or ramps 124 extending inward from the longitudinally extending flanges 106 between the curved indentations 110 and the lower member 96 includes a lip 126 extending downward from the transverse ends of the horizontal wall 122 of each elevated section 116. When the base 86 is assembled, the lips 126 are urged along the angled surface of the ramps 124 until they pass the ramps 124 and are seated on a flat, upper surface of the ramps 124 (see FIGS. 9B and 9C). At this stage, the upper and lower members 94, 96 are securely attached to one another.

Instead of forming ramps 124 on the upper member and the lips 126 on the lower member 96, a permanent form of connection for the upper and lower members 94, 96 may be provided by an adhesive such as glue or fastener members such as nails, screws and the like.

Each divider 90 has a pair of anchor portions 112, each supported and rotatable on a respective support projection 118, and an object support portion 128 coupled to the anchor portions 112 and extending through the opening 100 in the upper wall 98 of the upper member 94 of the base 86. To retain the dividers 90 in connection with the base 86, the anchor portions 112 each include a projection 130 at a transverse end which rests on the support projections 118 and is situated below the curved indentations 110. The presence of opposed bearing surfaces around the projections 130, formed by the support projections 118 and curved indentations 112, maintains projections 130 between the upper and lower members 94, 96 when connected together.

The projections 130 of the anchor portions 112 of each divider 90 may have a different cross-section and form than the remaining part of the anchor portion 112, e.g., it can be rounded in the form of a bullet while the remaining part of the anchor portion 112 has the X-shaped cross-section as shown.

Dividers 90 each include an arcuate opening 132 extending from a bottom edge between the anchor portions 112 and may be flared outward as shown to provide the object support portion 128 with a greater surface area for supporting objects.

To assemble the apparatus 84, the upper and lower members 94, 96 and dividers 90 are first constructed and the dividers 90 are inserted into engagement with the upper member 94 (while the upper member 94 is held upside down). Specifically, the dividers 90 are inserted through the opening 100 in the upper member 94 while the upper member 94 is held upside down such that the object support portion 128 is below the top wall 98 of the upper member 94. In view of the flaring of the object support portions 128, this cannot be achieved by simply dropping the dividers 90 (when oriented in their final orientation in the transverse direction of the upper member 94) into engagement with the curved indentations in the longitudinally extending flanges 106. Rather, the dividers 90 must first be turned away from their final orientation and inserted through the opening 100 and then turned back to their final orientation and placed onto the curved indentations 110. Preferably, all of the dividers 90 are inserted through the opening 100 first and then the projections 130 of each divider 90 are placed onto a pair of aligning curved indentations 110.

Once the dividers 90 are resting on the curved indentations 110, the lower member 96 is engaged with the upper member 94 by pressing the lower member 96 into the opening in the bottom surface of the upper member 94 to cause the lips 126 to slide along the ramps 124 and pass completely over the ramps 124. The apparatus 84 is thus ready for use for retaining objects, for enabling sorting of objects such as papers and documents, and for enabling browsing of objects such as file folders.

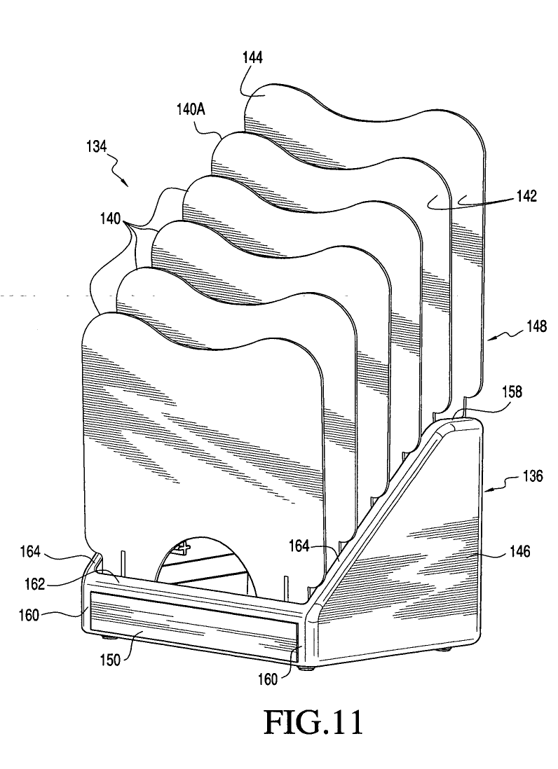

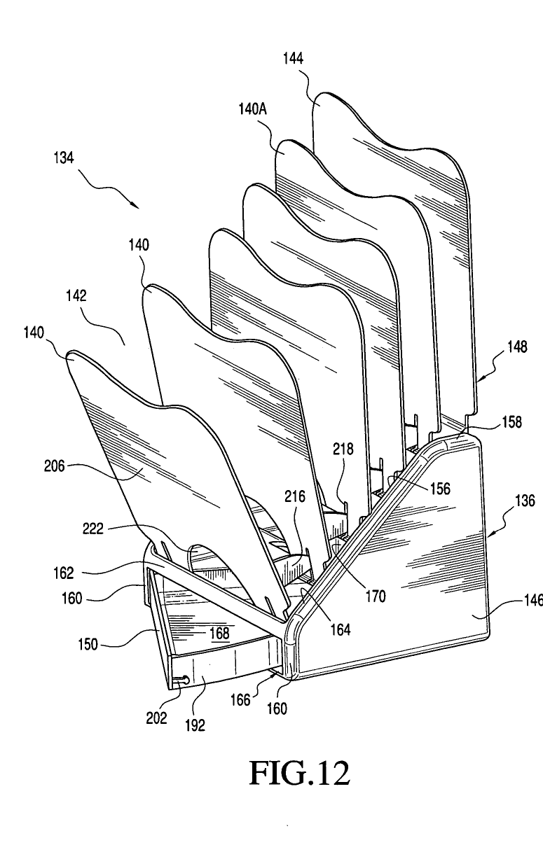

Referring now to FIGS. 11-15, another embodiment of a multi-section retaining/sorting/browsing apparatus in accordance with the invention is designated generally as 134 and comprises a base 136 including a plurality of parallel slots 138, and dividers 140, 140A arranged in connection with the slots 138. The dividers 140, 140A define object-retaining sections 142 therebetween, i.e., one object-retaining section 142 is defined between each adjacent pair of dividers 140, 140A. An additional object-retaining section 142 is defined between the uppermost divider 140A and a divider portion 144 of the base 136. Objects, such as file folders or the like, can be retained in the object-retaining sections 142.

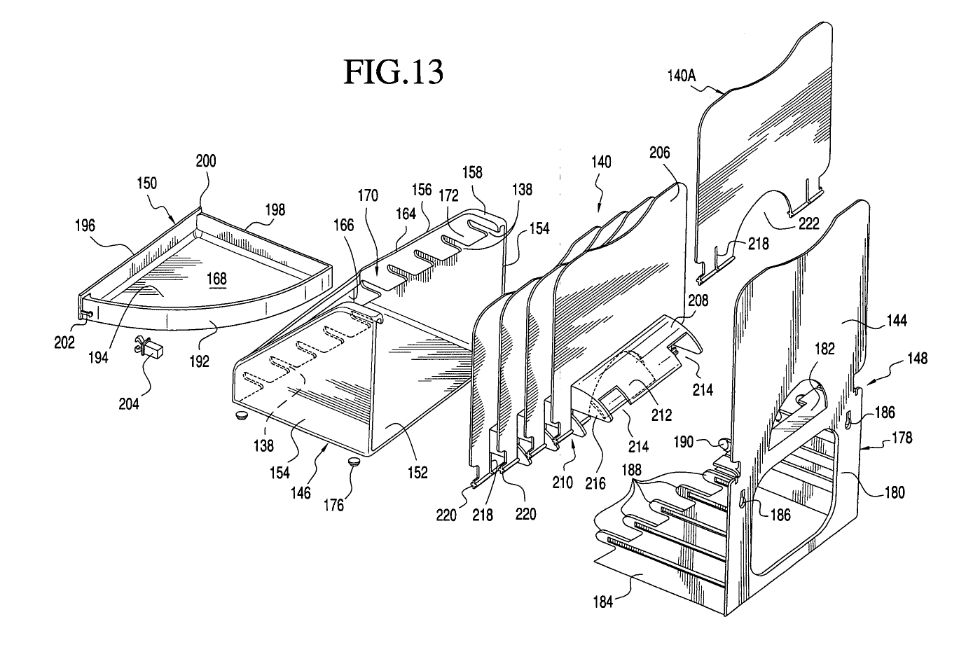

The base 136 is formed from three, preferably separate members, an outer, support member 146, an inner mounting member 148 and a drawer 150 rotatably mounted to the outer member 146 (see FIG. 13). Drawer 150 is an optional feature so that a base could be formed from only the outer and inner members 146, 148.

Outer member 146 includes a substantially planar lower wall 152, substantially planar side walls 154 extending upward from opposed edges of the lower wall 152, a multi-section front wall 156 extending upward from a front edge of the lower wall 152 and connected to the side walls 154, and a multi-section upper wall 158.

The front wall 156 includes two substantially vertical sections 160 adjacent the lower wall 152, a transverse section 162 and two rearwardly angled sections 164 extending in alignment with the vertical sections 160. A substantially rectangular opening 166 is defined between the vertical sections 160, the transverse section 162 and the lower wall 152 through which the drawer 150 rotates between a position in which it is entirely housed within the base 136 and a position in which the compartment 168 defined by the drawer 150 is exposed and accessible. Another opening 170 is defined between the transverse section 162, the angled sections 164 and the two sections of the upper wall 158. Dividers 140 extend through opening 170.

Outer member 146 also includes flanges 172 extending inwardly from edges of the vertical and angled sections 160, 164 of the front wall 156. Flanges 172 includes the plurality of substantially horizontal slots 138 opening rearward, the purpose of which is explained below (see FIG. 13). Slots 138 are aligned in parallel pairs, i.e., one slot 138 on each flange 172 aligns with a respective slot 138 on the opposed flange 172 to thereby form parallel pairs of horizontal slots. Moreover, the slots 138 are formed at different vertical elevations and may be formed with a common vertical separation therebetween, i.e., one inch between adjacent slots 138.

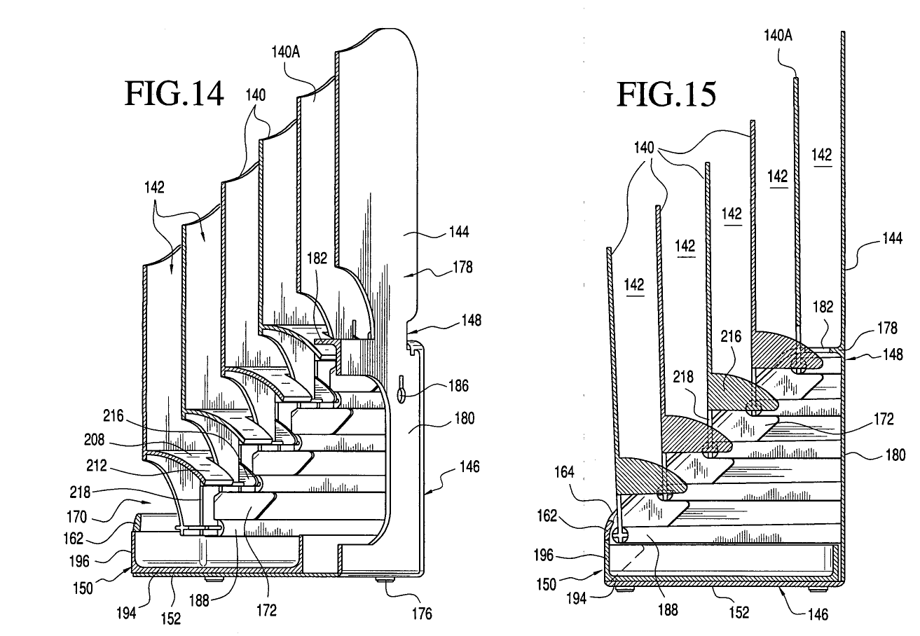

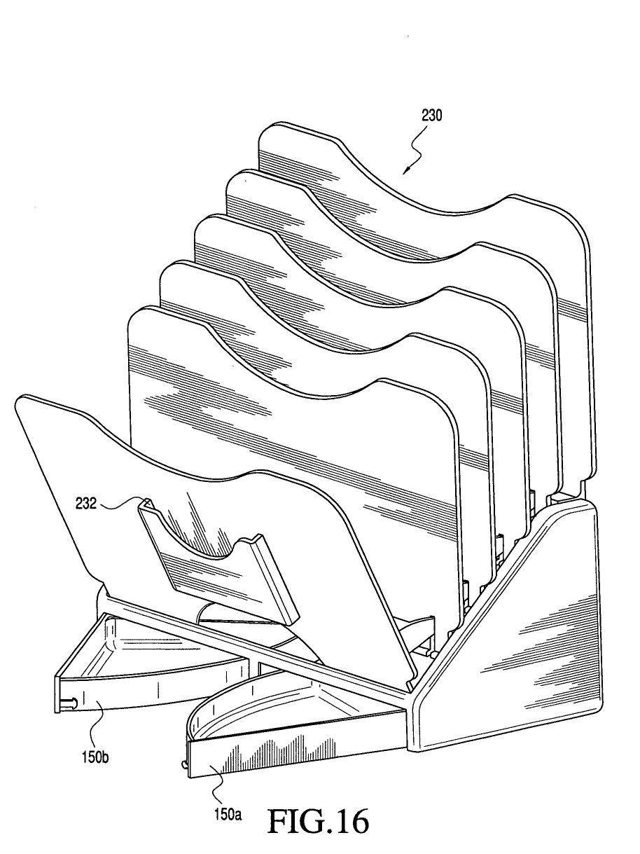

Contact pads 176 may be attached to the lower surface of the lower wall 152 (see FIGS. 14 and 15) to enable the apparatus 134 to stably rest on a horizontal surface.

Inner member 148 includes a substantially planar rear wall 178 having a base portion 180 and the divider portion 144 which are separated by a forwardly projecting transverse wall 182, and opposed substantially planar side walls 184. Rear wall 178 includes mounting holes 186 for mounting the apparatus 134 to a wall or other vertical surface, via appropriate mounting means such as nails or screws secured to the wall or other vertical surface. Mounting holes 186 may be key-holes as shown (see FIGS. 3 and 4). Side walls 184 include forward projections 188 which align with and enter into the slots 138 when the inner member 148 is engaged with the outer member 146 (see FIG. 15). Each forward projection 188 includes a groove 190 at the forward edge which defines an arcuate bearing surface, the purpose of which is explained below. Transverse wall 182 defines a shelf or support surface of the object-retaining section 142 defined between the uppermost divider 140A and the divider portion 144 of the rear wall 178.

Drawer 150 includes an arcuate side wall 192, a substantially planar lower wall 194, substantially planar front and side walls 196, 198 and protuberances 200 at the corner where the front and side walls 196, 198 meet. A locking projection 202 is arranged on the rear facing surface of the front wall 196 and engages with a locking member 204 arranged on the base 136 (see FIG. 13). Locking projection 202 and locking member 204 may be designed to allow the drawer 150 to be released after it is pressed inward, i.e., it will project outward slightly after being pressed in and then the user can grasp the front wall 196 and rotate the drawer 150 further outward to access the compartment 168.

Each divider 140 includes a substantially planar object support portion 206, an arcuate shelf 208 extending from a rear surface of the object support portion 206 and a pair of anchor portions 210 coupled to the object support portion 206. Object support portions 206 extend through the opening 170 defined by the base 136. Shelf 208 provides a support surface for objects in the object-retaining section 142 defined rearward of said divider 140. Shelf 208 includes a curved support wall 212 in which a pair of cut-outs 214 are formed, and side walls 216 alongside the cut-outs 214. Slots 218 are formed below the side walls 216.

The curved support wall 212 causes the bottom of objects placed thereon, such as file folders, to slide rearward thereby creating a rotational force which urges the divider 140 to stay in an upright position. Moreover, the curved support wall 212 prevents small objects, such as paper clips, from falling into the base 136.

Dividers 140 are placed one on top of the other with the side walls 216 of the lowermost divider 140 in each adjacent pair of dividers 140 passing through the slots 218 in the uppermost divider 140 in the adjacent pair (see FIGS. 13-15). Since there are no side walls passing the slots 218 in the lowermost divider 140, the slots 218 therein can be eliminated.

An important feature of the invention is that the dividers 140 are constructed with side walls 216 dimensioned to limit forward tilting movement of the lowermost divider 140 in view of engagement or contact between the side walls 216 of the lowermost divider in each adjacent pair and the upper end of the slot 218 of the uppermost divider in the adjacent pair at a predetermined maximum forward position. This is also aided by friction between the side walls 216 of the lowermost divider 140 and the edges of the uppermost divider 140 forming the slots 218. In this manner, even if heavy objects are placed into the object-retaining section 142, causing the divider 140 to tilt forward, it cannot tilt to a position in which the objects will spill out of the object-retaining section 142. Other constructions of dividers 140 which are effective to limit forward rotational movement of dividers are also envisioned within the scope and spirit of the invention. It is noted that the lowermost divider 140 does not require slots 218.

Divider 140A, the uppermost rotatable divider, is substantially similar to dividers 140 except that it does not include an arcuate shelf.

Anchor portions 210 include projections 220 at each outward end which are supported and rotatable in a respective aligning pair of slots 138. The projections 220 are retained in position at the front of the slots 138 by the presence of the forward projections 188 in the slots 138 and may bear against the bearing surfaces defined by the grooves 190 (see FIG. 15). Other constructions for retaining the projections 220 sandwiched between parts of the outer and inner members 146, 148 can also be used in the invention.

The anchor portions 210 in their entirety may have a uniform cross-section as shown. Alternatively, the projections 220 of each anchor portion 210 may have a different cross-section and form than the remaining part of the anchor portions 210, e.g., they can be rounded in the form of a bullet while the remaining part of the anchor portions 210 has the X-shaped cross-section as shown.

Dividers 140, 140A each include an arcuate opening 222 extending from a bottom edge between the anchor portions 210 and may be flared outward as shown to provide the object support portion 206 with a greater surface area for supporting objects. The curved support wall 212 of each divider 140 extends through the arcuate opening 222 of the immediately higher divider 140, 140A.

One manner to assemble the apparatus 134 is to first engage the dividers 140, 140A together (placing the side walls 216 in the slots 218 of the immediately higher divider 140, 140A) and then place them into the grooves 190 on the forward projections 188 of the inner member 148. The subassembly of the inner member 148 and dividers 140, 140A is then engaged with the outer member 146 by sliding the projections 220 on the anchor portions 210 of the dividers 140, 140A into the slots 138. Locking member 204 is connected to the inner member 146 and drawer 150 is then attached to the inner member 146.

The apparatus 134 is thus ready for use for retaining objects, for enabling sorting of objects such as papers and documents, and for enabling browsing of objects such as file folders. In particular, the apparatus 134 can be mounted to a wall by inserting two screws into the wall level with one another and spaced apart by a distance equal to the distance between mounting holes 186. The apparatus 134 is then hung on the screws by aligning the mounting holes 186 with the screws. Alternatively, the apparatus 134 can be used on a flat horizontal surface.

FIG. 16 shows another embodiment of a multi-section retaining/sorting/browsing apparatus, designated generally as 230, in accordance with the invention which differs from the apparatus 134 in that two drawers 150A, 150B are provided, each preferably having a respective locking mechanism as described above. Each drawer 150A, 150B opens toward the respective edge of the base 136. In addition, the lowermost divider 140 includes a pocket member 232 defining a compartment in which various objects such as post-it notes, writing utensils and the like can be stored.

Apparatus 134 and 230 can have varying widths to accommodate different sizes of files or folders, e.g., standard, A4 or legal size folders. A relatively wide apparatus can be manufactured for use with legal folders while a narrower apparatus can be manufactured for use with relatively small standard folders. Moreover, one drawer can be provided with substantially the same width as the apparatus, or two drawers can be provided, each with approximately one-half the width of the apparatus, or drawers can be omitted in some embodiments.

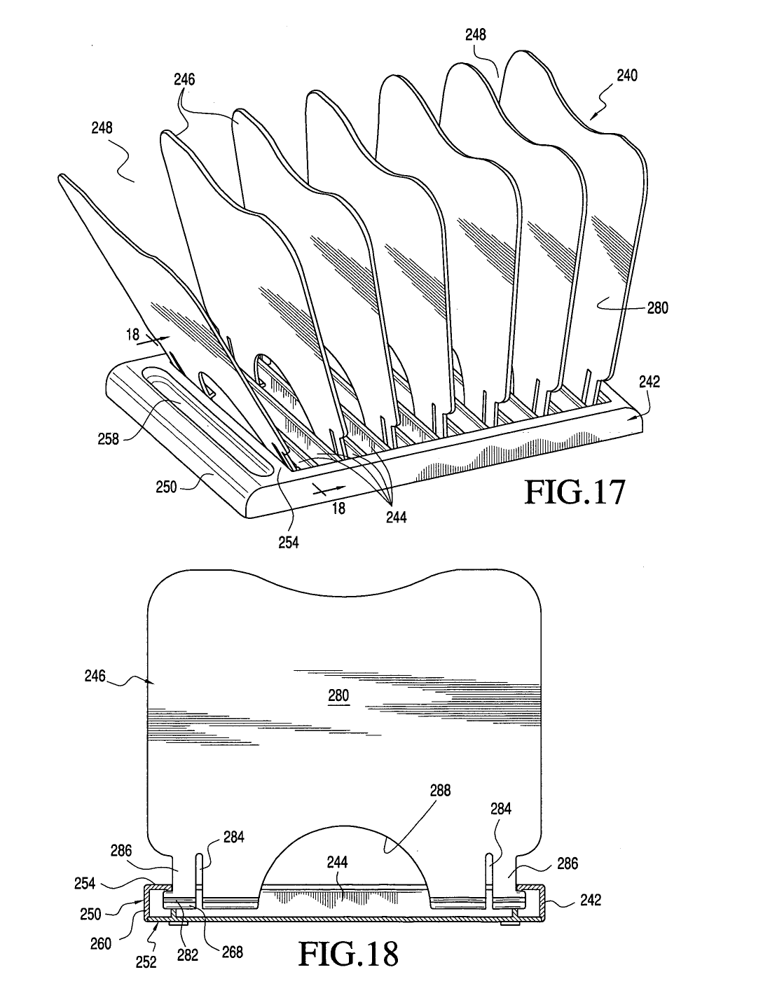

Referring now to FIGS. 17-19, another embodiment of a multi-section retaining/sorting/browsing apparatus in accordance with the invention is designated generally as 240 and comprises a base 242 including a plurality of parallel slots 244 and dividers 246 which can be arranged in connection with the slots 244. Slots 244 extend in a transverse direction of the base 242 and are therefore arranged alongside and substantially parallel to one another in a longitudinal direction of the base 242. The dividers 246 define object-retaining sections 248 therebetween, i.e., one object-retaining section 248 is defined between each adjacent pair of dividers 246. Objects, such as file folders or the like, can be retained in the object-retaining sections 248.

An objective of this embodiment is to enable various and different configurations of the dividers 246 in connection with the base 242, i.e., to provide the ability to freely insert the dividers 246 into desired slots 244. To this end, the base 242 is provided with a larger number of slots 244 than the number of dividers 246 in the apparatus 240, i.e., there are thirteen slots and seven dividers in the illustrated embodiment. The dividers 246 can be individually inserted into any unoccupied slot 244 to thereby provide the ability to create either uniform object-retaining sections 248 (when dividers 246 are placed in every other slot 244), large object-retaining sections 248 (e.g., when dividers 246 are placed in every third or fourth slot 244), or small object-retaining sections 48 (e.g., when dividers 246 are placed in each slot 244).

For this embodiment, it is not necessary to use all of the dividers 244. The dividers 246 can be easily inserted into and removed from connection with the slots 244 in the manner described below. Also, if the same number of dividers are provided as slots, the user still has the ability to use any number of dividers to form different configurations.

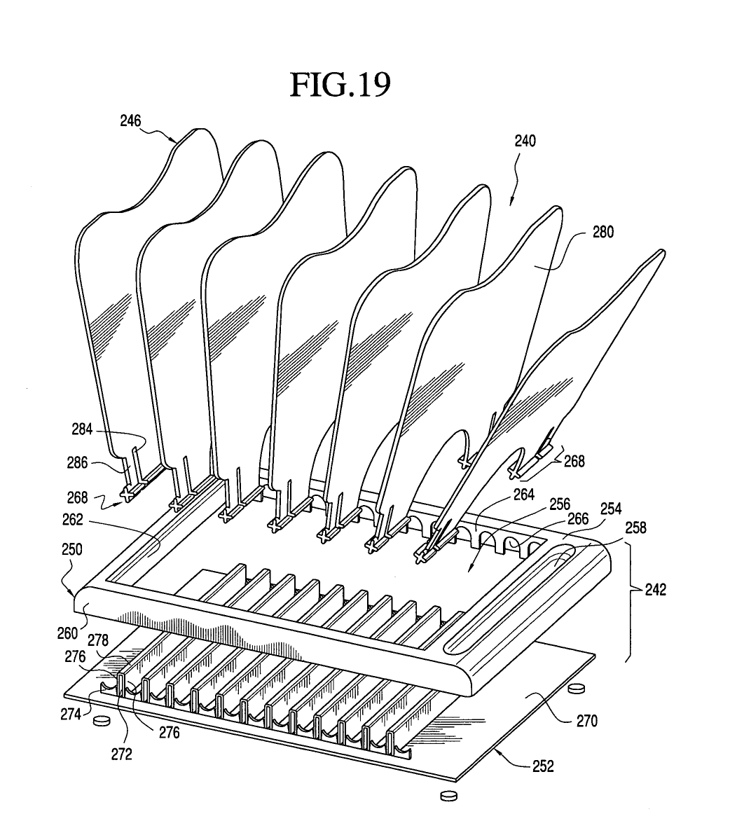

The base 242 is formed from two separate members, an upper member 250 and a lower member 252 (see FIG. 19). Upper member 250 includes a top wall 254 defining an opening 256 and having a transversely extending receptacle 258 on a longitudinal side of the opening 256. Receptacle 258 is designed to accommodate pencils, pens or other writing implements, or paper clips, erasers and other types of office products. Upper member 250 also includes peripheral side walls 260 and transversely extending flanges 262 projecting downward from the top wall 254 alongside opening 256. Upper member 250 also includes longitudinally extending flanges 264 projecting downward from the top wall 254 alongside the opening 256. Each longitudinally extending flange 264 defines end walls of the slots 244 and includes a plurality of curved slots or indentations 266 under which part of an X-shaped anchor portion 268 of a respective divider 246 is placed (see FIG. 18).

Lower member 252 includes a planar portion 270, a plurality of transversely extending elevated sections 272 arranged on the upper surface of the planar portion 270 and a plurality of support projections 274 arranged on the upper surface of the planar portion 270. Each elevated section 272 includes a pair of vertical walls 276 and a horizontal wall 278 raised above the planar portion 270 by the vertical walls 276. Instead of a pair of vertical walls 276, other constructions for raising or elevating horizontal wall 278 above the planar portion 270 of the lower member 252 are also possible. The horizontal walls 278 of the elevated sections 272 preferably positioned to be even with the top wall 254 of the upper member 250.

Support projections 274 define a curved bearing surface on which part of the anchor portions 268 of the dividers 246 are supported and rotate (see FIG. 18).

Slots 244 are defined, on the longitudinal sides, by a pair of vertical walls 276 or, in the case of the slots 244 at the longitudinal ends of the base 242, by one vertical wall 276 and an opposed transversely extending flange 264. As such, flipping movement of the dividers 246 arranged in connection with the slots 244 is limited by contact with the elevated sections 272, or by contact with the upper wall 254 of the upper member 250. On the transverse sides, the slots 244 are defined by part of the longitudinally extending flanges 262 and support projections 274.

The upper member 250 may include an opening in a bottom surface into which the lower member 252 is positioned and then either permanently or removably connected to the upper member 250. In this embodiment, since the dividers 246 can be removed from the slots 244 through opening 256 when the upper and lower members 250, 252 are connected together, the upper and lower members 250, 252 could be permanently connected together, or possibly even formed as an integral unit. If a removable connection is sought, the connecting structure described above in connection with the embodiment shown in FIGS. 9A-10 may be used.

Each divider 246 has a pair of anchor portions 268, each supported and rotatable on a respective support projection 274, and an object support portion 280 coupled to the anchor portions 268 and extending through the opening 256 in the upper wall 254 of the upper member 250 of the base 242. To retain the dividers 246 in connection with the base 242, the anchor portions 268 each include a projection 282 at a transverse end which rests on the support projections 274 and is situated below the curved indentations 266. The presence of opposed bearing surfaces around the projections 282, formed by the support projections 274 and curved indentations 268, maintains projections 282 between the upper and lower members 250, 252 when connected together.

To enable the dividers 246 to be inserted into connection with the base 242 through opening 256, a slit 284 is formed extending upward from a lower edge of each divider 246 through the anchor portions 268 to form a spring portion 286 (see FIG. 18). The presence of slits 284 provides the spring portion 286 (which includes the projections 282 and an adjoining part of the anchor portion 268) with inward flexibility so that it is possible to flex the projections 282 inward, and thus allows the dividers 246 to be inserted into engagement the base 242 by downwardly pushing the projections 282 under the upper wall 254 of the upper member 250 while the spring portions 286 are flexed inward. Although the slit 284 is shown formed through the anchor portion 268, i.e., part of the anchor portion 268 is on each side of the slit 284, it is conceivable that the anchor portion 268 is formed only on the spring portion 286.

For this embodiment, it is important to consider the materials from which the dividers 246 will be constructed to enable the spring portion 286 to be able to flex. For example, the dividers 246 may be constructed of a resilient material such as polycarbonate or ABS, or other known plastic material with sufficient rigidity yet slightly flexible when in narrow lengths. Alternatively, only the lower part of the dividers 246 including the spring portions 286 may be constructed of a resilient material.

The projections 282 of the anchor portions 268 of each divider 246 may have a different cross-section and form than the remaining part of the anchor portion 268, e.g., it can be rounded in the form of a bullet while the remaining part of the anchor portion 268 has the X-shaped cross-section as shown.

Dividers 246 each include an arcuate opening 288 extending from a bottom edge between the anchor portions 268 and may be flared outward as shown to provide the object support portion 280 with a greater surface area for supporting objects.

One manner to assemble the apparatus 240 entails first constructing the upper and lower members 250, 252 and dividers 246 and then connecting the upper and lower members 250, 252 together. The dividers 246 are individually inserted into an unoccupied slot 244 by pressing the projections 282 on the anchor portions 268 of the divider 246 inward and then pressing the projections 282 under the upper wall 254 of the upper member 250 of the base 242. The user is free to select the number of dividers 246 to be used and the size of the object-retaining sections 248, the latter by appropriate selection of the location of the slots 244 into which the dividers 246 are placed. The apparatus 240 is thus ready for use for retaining objects, for enabling sorting of objects such as papers and documents, and for enabling browsing of objects such as file folders.

If the user should desire a change in the configuration of the apparatus 240, they can remove each divider 246 as desired by pressing the spring portions 286 of the divider 246 inward and lifting the divider 246 out of engagement with the base 242. The divider 246 can then be re-inserted into another slot 244, if so desired.

The various bases and dividers described above can each be made of various materials, such as aluminum, wood and plastic, so that various combinations of materials are possible.

It should be clear that various modifications and alterations can be made within the scope of the present invention. None of the features or individual components of the apparatus described above are essential to any single embodiment and each feature can be substituted for by an equivalent structure. For example, the base shown in FIGS. 9A-10 may be used independent of the dividers shown therein, i.e., with different dividers, and the dividers shown therein may be used with other bases. Also, various features of one embodiment can be combined with features of other embodiments, consistent with proper operation thereof, within the scope of the present invention. All of the embodiments can be assembled by pressing the dividers down through the slots and into the cavity(ies), when the materials have sufficient resiliency or elasticity.

1. A multi-section retaining/sorting/browsing apparatus, comprising:
a base including a plurality of pairs of parallel slots vertically spaced from one another; and
a plurality of dividers defining object-retaining sections between adjacent ones of said dividers and support surfaces for objects to be retained in said object-retaining sections, each of said dividers being arranged in connection with a respective one of said pairs of slots such that said object-support sections defined by said dividers are at different vertical elevations.

2. The apparatus of claim 1, wherein said base includes support means for enabling said base to rest on a horizontal surface and mounting means for enabling said base to be mounted to a vertical surface.

3. The apparatus of claim 1, wherein said base comprises an outer support member and an inner mounting member defining an opening therebetween, said dividers extending through said opening, said outer support member including opposed, inwardly extending flanges, said slots being defined in said flanges.

4. The apparatus of claim 3, wherein said inner member includes a substantially planar rear wall having a base portion and a divider portion, and a transverse wall separating said base portion and said divider portion, said divider portion forming an object-retaining section with an uppermost one of said dividers while said transverse wall defines said object support surface of said object-retaining section.

5. The apparatus of claim 4, wherein said inner member includes retaining means for retaining part of said dividers in said slots.

6. The apparatus of claim 1, wherein each divider includes a substantially planar object support portion, an arcuate shelf extending from a rear surface of said object support portion and a pair of anchor portions coupled to said object support portion.

7. The apparatus of claim 6, wherein said shelf includes a curved support wall having a pair of cut-outs, side walls alongside said cut-outs and slots formed below said side walls, said side walls of each of said dividers being arranged in said slots of an immediately higher one of said dividers.

8. The apparatus of claim 7, wherein said side walls and sad slots are formed to limit forward tilting movement of said dividers.

9. The apparatus of claim 7, wherein said dividers each include an arcuate opening extending from a bottom edge between said anchor portions, said shelf of an immediately lower one of said dividers passing through said arcuate opening of each one of said dividers.

10. The apparatus of claim 1, wherein said base includes a rear wall and mounting means arranged in connection with said rear wall for mounting said base to a vertical surface.

11. The apparatus of claim 10, wherein said mounting means comprise mounting holes.

12. The apparatus of claim 1, wherein said base further comprises at least one drawer defining a compartment and rotatably outward from a front face of said base to expose said compartment.

13. The apparatus of claim 12, wherein a lowermost one of said dividers includes a pocket on an outer surface defining a compartment.

14. A multi-section retaining/sorting/browsing apparatus, comprising:
a base including a plurality of parallel slots; and
a plurality of dividers each removably arranged in connection with a respective one of said slots on said base, said dividers defining object-retaining sections between adjacent ones of said dividers,
each of said dividers including slits extending upward from a lower edge of said divider to form biased spring portions at transverse edges of said dividers, said spring portions enabling said dividers to be inserted into and removable from engagement with said base through said slots.

15. The apparatus of claim 14, wherein said dividers are made of a resilient material.

16. The apparatus of claim 14, wherein said base defines a larger number of slots that the number of said dividers such that multiple, different configurations of dividers on said base are possible.

17. The apparatus of claim 14, wherein each of said dividers has a pair of separated anchor portions and an object support portion coupled to said anchor portions and extending through said respective one of said slots to provide a support for retaining objects, said anchor portions being rotatably retained in connection with said base to enable said dividers to be flipped forward and backward in a longitudinal direction.

18. The apparatus of claim 17, wherein each of said anchor portions of each of said dividers includes a projection extending outwardly to a position below an overlying portion of said base, said projections being formed on said spring portions, said spring portions being outwardly biased.

19. The apparatus of claim 17, wherein said base includes an upper member and a lower member, said anchor portions being partially retained between said upper and lower members.

20. The apparatus of claim 17, wherein each of said dividers has an opening extending from a bottom edge of said dividers and situated between said anchor portions.
